(19) United States
(12) Patent Application Publication
(10) Pub. No.: US 2007/0178911 A1
(43) Pub. Date: Aug. 2, 2007

(54) Automatic generation of signal strength map for location determination of mobile devices

(75) Inventors: Markus Baumeister, Aachen (DE); Joachim Kahlert, Aachen (DE); Olaf Wischhusen, Aachen (DE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/569,780

(22) PCT Filed: May 31, 2005
(86) PCT No.: PCT/IB05/51771

§ 371 Date: Nov. 29, 2006

(30) Foreign Application Priority Data
Jun. 9, 2004 (EP) 04102622.0

(51) Int. Cl. H04Q 7/20

(52) U.S. Cl. 455/456.1

(57) ABSTRACT

The present invention provides a mobile device and a method for generating and maintaining a signal strength database that provides an assignment between a location within a building and corresponding signal strengths of signals that are emitted by a plurality of access points of a wireless data communication network. The inventive mobile device is adapted to determine its own position by making use of a trigonometric technique on the basis of dedicated reference points or access points of the network. The mobile device is further adapted to measure the signal strength of signals being transmitted by the plurality of access points. A determined position of the mobile device is then assigned to a set of measured signal strengths and stored as an entry of the database. Preferably, the mobile device is attached to a trolley like device that is subject to frequent movement through a building.

The present invention relates to the field of locating and tracking mobile devices of a wireless network.

The universal application of mobile computing devices in wireless networks provides an implementation of location aware systems and services. Granting of access to data or application programs of the wireless network can be effectively implemented as a function of the location of a mobile computing device. For example, a user making use of a mobile computing device might be enabled to make use of a nearby printer when requesting printing of a document. Moreover, in a medical environment it is of advantage when the location of a patient, a doctor, or other medical personnel is known. In an emergency situation a doctor can then be automatically provided with patient related data of a nearby patient. Hence, medical personnel can be automatically provided with patient related data based on the relative distance between a particular patient and a medical personnel making use of a mobile computing device.

Location aware systems and services universally provide a huge variety of application scenarios where location information of a user and his mobile computing device is a key feature. For example, location information can be effectively exploited to guide a visitor or a customer to a distinct location within a building or to track the position of a user.

In principle, determination of a location of a user and a mobile computing device can be realized by a plurality of different positioning techniques, like e.g. a global positioning satellite system (GPS). However, in particular inside buildings the GPS system is not sufficiently applicable and does not provide a required resolution.

A reliable approach of determining the position of a mobile computing device within the coverage of a wireless network makes use of the data communication infrastructure of the network itself. Since the data communication wireless network provides a plurality of spatially distributed access points, corresponding communication signals of the various access points can be effectively exploited in order to determine the position of a mobile computing device.

Signal strength of a signal that is transmitted by an access point varies due to the distance from the access point the intervening walls, and signal superimposition. Thus the signal strength measured by a mobile device provides information on the distance between the mobile device and an access point. Taking into account a plurality of various access points, any location inside a building can be effectively characterized by a set of signal strengths of signals that are transmitted by the plurality of access points and measured at the location. Since signal strength does not decrease linearly with distance, this characterization of a location is typically provided by a signal characteristic database that was measured inside the building. In this way, a location of a mobile device can be determined by measuring the signal strengths of signals transmitted by a plurality of access points and by comparing the measured signals with entries of the signal characteristic database that are indicative of a location for a measured set of signal strengths.

The document WO 03/075125 provides a location aware data network. Therein, a system is disclosed that associates physical locations with network linked devices in a network to which such devices are connected. This system can perform calculations to approximate distance from a known access point as a function of signal strength attenuation. In addition to calculations, the system can also store associations of signal characteristics and the corresponding locations. This information can be stored in a signal characteristic database. A network administrator generates this signal characteristic database by measuring predefined signal characteristics at different locations and storing the measured characteristics for each of the locations.

Hence, in the prior art a signal characteristic database has to be generated manually, i.e. at different locations a network administrator measures a set of signals and stores the measured signals for each of the locations. In particular for wireless communication or data networks providing a huge area of coverage, the generation of such a signal characteristic database may become very time intensive and cumbersome. Moreover, signal characteristic databases also have to be maintained on a frequent basis whenever changes to the access points, the data communication network, the placement of furniture, or the mobile devices occur. Additionally, manual generation of a signal characteristic database is rather expensive due to the costs of human resources and may further be error prone because of a network administrator entering wrong data into the signal characteristic database.

The present invention therefore aims to provide an improved and facilitated generation and maintenance of a database for determining locations of mobile computing devices of a wireless data communication network.

The present invention provides a mobile device for generating a database for a wireless data communication network that has at least a first, a second and a third access point. The inventive mobile device comprises means for determining a position of the mobile device, means for measuring at least a first, a second and a third signal that are wirelessly transmitted by the at least first, second and third access points and means for storing the position of the mobile device and the at least first, second and third measured signals in the database.

The wireless data communication network is typically based on radio frequency (RF) communication techniques that are based on e.g. IEEE 802.11 or wireless fidelity (Wi-Fi) communication standards. The wireless data communication network to be used with this invention is by no means restricted to RF communication networks. In principle, the inventive mobile device can be universally adapted to any other wireless data communication network, that is based on e.g. infrared (IR) communication technique.

The means for determining the position of mobile device are adapted to make use of an at least first, second and third reference point on the basis of a trigonometric technique. The trigonometric technique in turn may be based on either a triangulation or a trilateration procedure. Making use of the triangulation procedure, the means for determining the position of the mobile device are adapted to determine various angles specifying the direction that points to the at least first, second and third reference points. Having knowledge of these angles, i.e. the directions pointing to the various reference points, and/or knowledge of the orientation of the mobile device and having further knowledge of the location of the first, second and third reference points that are stationary, the position of the mobile device can be sufficiently determined.

In principle, in a similar way the trilateration procedure can alternatively be used to determine the location of the mobile device. In this case a delay of signals that are received at the mobile device and that are synchronous transmitted by the first, second and third reference points is indicative of the position of the mobile device. However, for the present invention a triangulation based location determination of the mobile device is preferred. It can be implemented into existing RF-based networks whereas implementation of a trilateration procedure inherently requires an appropriate functional modification of the access or reference points.

Depending on the application purpose and the particular trigonometric technique at least two, three or four reference points are necessary to unequivocally determine the position of the mobile device. For example, when the mobile device is only subject to a two dimensional translation, e.g. a translation in the x-y-plane but remains at a given position in the z direction, three reference points are generally be sufficient to unequivocally determine the position of the mobile device when the trigonometric technique is based on a triangulation procedure. When the mobile device also features means for determining its direction, sufficient determination of its location might be enabled on the basis of only two reference points. A similar configuration making use of a trilateration procedure may require a at least three reference points in order to unequivocally determine the position of the mobile device.

However, the at least first, second and third reference points are adapted to emit predefined reference point specific signals. The means for determining the position of the mobile device are in turn adapted to receive these reference point specific signals in order to identify the reference points and to perform the triangulation or trilateration procedure.

The means for measuring the at least first, second and third signals being wirelessly transmitted by the at least first, second and third access points, respectively are preferably adapted to measure the strength of the at least first, second and third signals. Hence, the means for measuring of the at least first, second and third signals are therefore adapted to measure the signal attenuation of the first, the second and the third signals at the position of the mobile device. The attenuation of the at least first, second and third signals transmitted by the at least first, second and third access points of the wireless data communication network vary in space and can therefore be effectively exploited for determination of the location of mobile computing devices accessing the wireless data communication network via the at least any of the first, second and third access points.

The means for storing are adapted to store the position of the mobile device and the at least first, second and third signals as an entry of the database. In this way a database entry is indicative of an assignment between a particular position and a corresponding set of at least first, second and third signals received at this position. By moving the mobile device to a plurality of different positions within the coverage of the wireless data communication network, the database may finally provide a complete mapping between sets of signal strength and positions of the mobile device.

In this way a mobile computing device that is only adapted to measure the signal strength of at least a first, second and third signals that are wirelessly transmitted by at least first, second and third access points of the wireless data communication network can effectively determine its position by making use of the database.

Preferably, the reference points for determination of the location of the inventive mobile device coincide with the access points of the wireless data communication network. Hence, the functionality of the reference point, i.e. transmitting reference point specific signals is completely implemented by the access points. In this way, installation of additional infrastructure is not needed in order to implement an autonomous location determination of the mobile device.

The inventive device therefore allows to autonomously generate and to maintain a signal strength database that can be exploited by various mobile computing devices. Location determination based on signal strength measurement represents a fast and very efficient approach to location determination, since neither the access points nor the mobile computing devices have to be equipped with additional dedicated hardware components.

In comparison, triangulation or trilateration based location determination is rather slow due to the required scanning of a steradian. Furthermore, it requires sophisticated hardware components. The inventive mobile device is therefore equipped with two different systems for location determination. The first system, the triangulation based positioning system is used in order to determine the physical location of the mobile device in order to calibrate the second position system that is based on a measurement of signal strengths.

According to a further preferred embodiment of the invention, the mobile device further comprises a motion detector that is adapted to determine if the mobile device is stationary. Determining of the position of the mobile device by making use of a trigonometric technique, either triangulation or trilateration takes a predefined time interval that may easily exceed a few seconds. A trigonometric based technique for position determination of the mobile device requires that the mobile device remains stationary at a given position during the position determination. Therefore, it has to be ensured that during the position determination of the mobile device, the mobile device is not subject to a movement.

Moreover, by means of the motion detector it can further be ensured that measurement of signal strengths and position determination occur at the same position of the mobile device in case that the two measurement procedures, measuring of signal strength and determination of the position of the mobile device are performed sequentially. However, determination of the position of the mobile device as well as measuring of the strength of the at least first, second and third signals can also be performed simultaneously.

Preferably, the mobile device is designed to be moved but is not equipped with means for changing its position autonomously. When the mobile device becomes subject to a movement during the determination of its position or during a measuring of the at least first, second and third signals, the measured data is evidently falsified and should not be used for the generation of the database. In such a case the measured data is discarded and/or the measurement that is in progress is interrupted. Alternatively, the motion detector can also be used in order to prevent the starting of a measurement procedure when the mobile device is currently moved.

According to a further preferred embodiment of the invention, the means for determining of the position of the mobile device are adapted to make use of a pivoting beam antenna and/or a phased antenna array. In this embodiment, the means for determining the position are adapted to make use of a triangulation procedure. Hence, the means for determining of the position of the mobile device are adapted to determine the direction at which the at least first, second and third access points are located with respect to the position and the orientation of the mobile device.

Both the pivoting beam antenna and/or the phased antenna array are adapted to determine an angle at which reference point specific signals are received. Preferably, the at least first, second and third reference points coincide with the at least first, second and third access points. Thus, the first, the second and the third access points also serve as a first, a second and a third reference point. For example in a IEEE802.11 based communication network, the access points regularly transmit access point specific beacons. By making use of the phased antenna array the angle at which a particular beacon is received by the mobile device can be at least roughly determined.

Additionally, the pivoting beam antenna can be used for a more precise determination of the direction of the at least first, second and third reference or access points. In this case, the tilting beam antenna can be effectively used in order to scan a huge range of steradians. The angle or steradian at which a particular beacon or reference point specific signal is maximal specifies the angle and hence the direction pointing to the reference point. This angle is then exploited for the triangulation based position determination of the mobile device.

Preferably, when the mobile device has a tilting beam antenna and a phased antenna array, a combined usage of these two antennas allows for a fast, precise and effective determination of the relevant direction information of the at least first, second and third access points. In particular, by means of the phased antenna array, the direction towards a reference or access point can be roughly determined. This rough determination can then be effectively exploited by means of the tilting beam antenna. In this case the tilting beam antenna only has to scan a steradian that corresponds to the rough direction determination performed by means of a phased antenna array. Hence, the pashed antenna array is used for a coarse determination of the direction to a reference point and thereafter by means of the tilting beam antenna, e.g. a parabolic antenna, the angle can be determined more precisely.

According to a further preferred embodiment of the invention, the mobile device further comprises a wireless communication module for enabling wireless data transmission between any of the at least first, second and third access points and the mobile device. Preferably, by means of the wireless communication module the strength of the at least first, second and third signals that are wirelessly transmitted by the at least first, second and third access points is measured. Hence the wireless communication module serves as a means for measuring the attenuation of the at least first, second and third signals that are transmitted by the at least first, second and third access points of the wireless data communication network. When for example the wireless data communication network is based on an IEEE802.11 transmission standard, the wireless communication module of the mobile device is preferably implemented as a 802.11 extension card for personal computers or similar portable computing devices.

In this way, the mobile device is enabled for wireless data transmission to the wireless data communication network via the at least first, second and third access points of the wireless data communication network. Hence, any data, like position specific data or signal strength specific data, that is measured by the mobile device can be transmitted to the wireless data communication network. Consequently, the database collecting location specific signal strengths characteristics can either be stored locally in the mobile device or it can be stored anywhere in the data communication network.

Moreover, various databases can be used in order to collect location specific data, to store location specific data and/or to process the collected data. Depending on their field of application, these various databases can either be stored locally in the mobile device or by means of any other suitable network resource. Wireless transmission of obtained data that is either specific of position information or signal strength information, it can be processed locally or can be transmitted to any component of the wireless data communication network.

According to a further preferred embodiment of the invention, the mobile device further comprises means for requesting identification signals to be wirelessly transmitted by the at least first, second and third reference points. The means for requesting identification signals are adapted to emit a request signal that can be received by the at least first, second and third reference points and/or the at least first, second and third access points of the wireless data communication network. In response to receiving a request signal, the at least first, second and third reference points and/or the at least first, second and third access points start to emit identification signals or a sequence of identification signals that are specific for each reference or access point.

This is of particular advantage when the means for determining the position of the mobile device make use of the tilting beam antenna. Determination of an angle by making use of the tilting beam antenna typically requires a scan of a particular steradian. Depending on the resolution such a scan incorporates a number of scanning positions of the tilting beam antenna. Typically, at each of these scanning positions, the tilting beam antenna has to receive at least one identification signal that has been transmitted by a particular reference or access point.

For example, subsequent beacons that are transmitted by the access points of a IEEE802.11 based wireless network feature a time gap which is around 100 milliseconds. Hence, a scan making use of only ten different scanning positions would at least require 1 second. The tilting beam antenna is preferably adapted to precisely determine the angle at which an access or reference point of the data communication network is located. Therefore, the tilting beam antenna has to scan a vast amount of different scanning positions in order to precisely determine a steradian required for the triangulation procedure. In this case the time interval between any two beacons of the IEEE802.11 standard is much too large.

Therefore, the reference points or access points are adapted to emit a sequence of identification signals at a much higher rate in order to allow a fast and efficient scanning procedure making use of the tilting beam antenna. The means for requesting identification signals are therefore an effective tool for initiating the reference and/or the access points of the data communication network to transmit a sequence of identification signals that can be effectively used by a scanning of the tilting beam antenna of the mobile device.

According to a further preferred embodiment of the invention, the mobile device further comprises fixing means that are adapted to attach the mobile device to a trolley like device that is moveable within the area of coverage of the wireless data communication network. Since the mobile device is preferably not designed for autonomous movement, it is designated to be moved with any other mobile device that is preferably subject to regular movements within the area of coverage of the wireless communication network. For example the inventive mobile device can be attached to any trolley like base frame or rack that are used by cleaning personnel. Such cleaning racks are regularly moved through a building and are frequently stationary at a various positions.

While a cleaning staff is for example cleaning a window, the rack is typically stationary and the mobile device that is attached to the cleaning personnel's rack can perform the dedicated measurement. Alternatively, the mobile device can also be attached to e.g. a wheelchair or a sick bed when the wireless data communication network is implemented in a medical environment like a hospital.

By attaching the mobile device to the trolley like device that is preferably regularly moved within the area of coverage of the wireless data communication network, the database can be generated and maintained autonomously by the mobile device and the interplay between the mobile device and the various access and reference points of the data communication network. Hence, generation and maintenance of the signal characteristic database no longer has to be performed by a network administrator but results as a by-product of regular movements of existing devices.

In another aspect, the invention provides a network system comprising a wireless data communication network that has at least a first and a second access point, a mobile device that is adapted to determine its position and that is further adapted to measure at least a first and a second signal that are wirelessly transmitted by the at least first, second and third access points. The network system further comprises a database that is adapted to store the location of the mobile device with the strength of the at least first, second and third signals. The mobile device is adapted to determine its own position by means of at least a first and a second reference point on the basis of a trigonometric technique.

Hence the location of the mobile device and the strength of the at least first, second and third signals are determined independently and are assigned by means of the database. By storing the location of the mobile device with the strength of corresponding first, second and third signals measured at the location of the mobile device, each location within the coverage of the wireless data communication network can be assigned with a set of strengths of the at least first, second and third signals. The database can either be stored by means of the mobile device or somewhere in the data communication network provided that the mobile device can access the database for storing assignments between location and corresponding signal strengths.

According to a further preferred embodiment of the invention, the at least first, second and third access points serve as the at least first, second and third reference points. In this way, the access and reference points coincide. Therefore, the mobile device for generating the database can be used with almost any wireless data communication network without implementation of additional infrastructure for determination of the position of the mobile device. Hence, position determination of the mobile device that is based on a trigonometric technique, either triangulation or trilateration, can effectively make use of the existing infrastructure of the wireless data communication network, namely the at least first, second and third access points.

In another aspect, the invention provides a method of generating a database for a wireless data communication network that has at least a first, a second and a third access point. The inventive method makes use of a mobile device and comprises the steps of determining a position of the mobile device by means of at least a first, a second and a third reference point on the basis of a trigonometric technique, measuring of at least a first, a second and a third signal that are wirelessly transmitted by the at least first, second and third access points, assigning the at least first, second and third signals to the position of the mobile device and storing the assignment between the at least first, second and third signals and the position of the mobile device as an entry of the signal database.

By subsequently moving the mobile device to different positions within the area of coverage of the wireless data communication network, various locations are determined and characterized with at least the strength of first, second and third signals that are wirelessly transmitted by the at least first, second and third access points. Determination of the position of the mobile device is based on a trigonometric technique, either triangulation or trilateration and makes use of at least first, second and third reference point. Preferably reference points and access points of the wireless data communication network coincide.

Determination of the position of the mobile device and measuring of the strength of the at least first, second and third signals can either be performed sequentially or simultaneously. In both cases it has to be guaranteed that the mobile device is not subject to any movement during a position determination or a signal strength measurement.

In still another aspect, the invention provides a computer program product for generating a database for a wireless data communication network that has at least a first, a second and a third access point. The computer program product comprises program means for performing a trigonometric calculation procedure for determining a position of a mobile device by means of at least a first, a second and a third reference point. The computer program product further comprises program means for assigning the position of the mobile device with at least first, second and third signals that are transmitted by the at least first, second and third access points and that are measured by the mobile device. The computer program product further comprises program means for storing of the assignment between the at least first, second and third signals and the position of the mobile device as an entry of the signal database.

According to a further preferred embodiment of the invention, the computer program product further comprises computer program means that are adapted to perform a weighting procedure between at least a first and a second database entry if the distance between the position of the first database entry and the position of the second database entry is below a predefined threshold. For example, when a distinct position is subject to a repeated measurement and when the repeated measurement deviates from the former measurement that is already stored in the database, the former as well as the repeated measurement may both become subject to a weighting procedure.

For example when for the same position different signal strengths have been measured it is reasonable to determine an average value and to store the average value as the database entry. In this way, measurement errors or deviations that may occur during the measurement can be effectively minimized by repeated measurements. Moreover, the weighting function may also provide interpolation functionality for locations that have not been subject to a measurement yet. Hence, the computer program product provides an effective means for an optimization of the database.

According to a further preferred embodiment of the invention, the computer program product comprises computer program means that are adapted to discard a trigonometric calculation if during determination of the position a motion of the mobile device is detected by means of a motion sensor. The computer program product therefore serves to control the stationary position of the mobile device during determination of its position and during measurement of the at least first, second and third signals.

Further, it is to be noted that any reference signs in the claims of the present application shall not be construed as limiting the scope of the invention.

In the following preferred embodiments of the invention will be described in detail by making reference to the drawings in which:

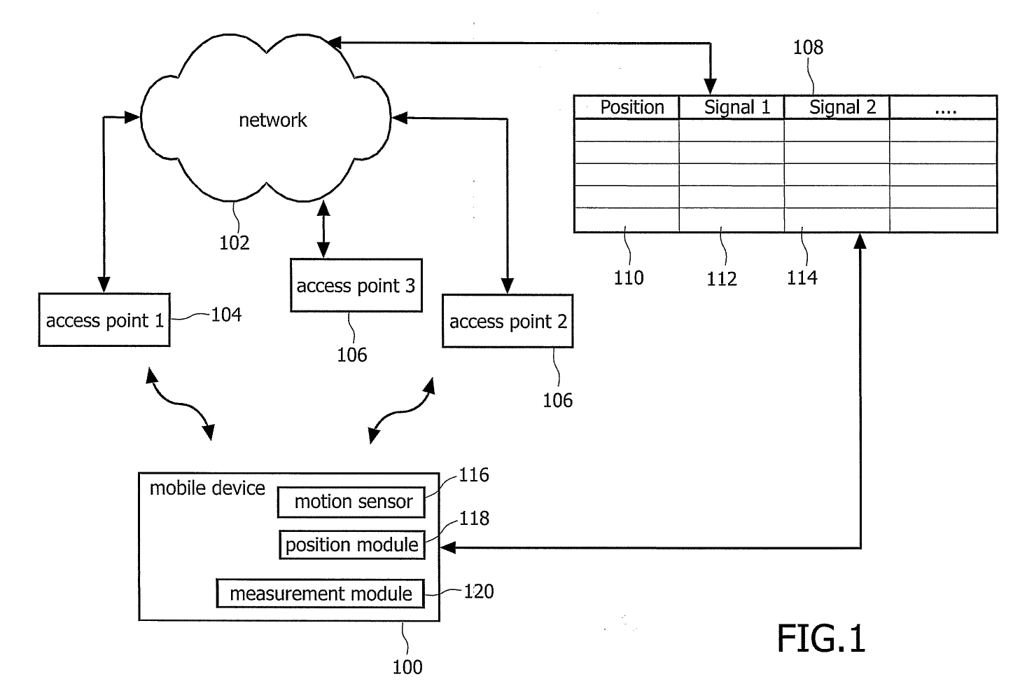

FIG. 1 illustrates a block diagram of a network system with a database and a mobile device,

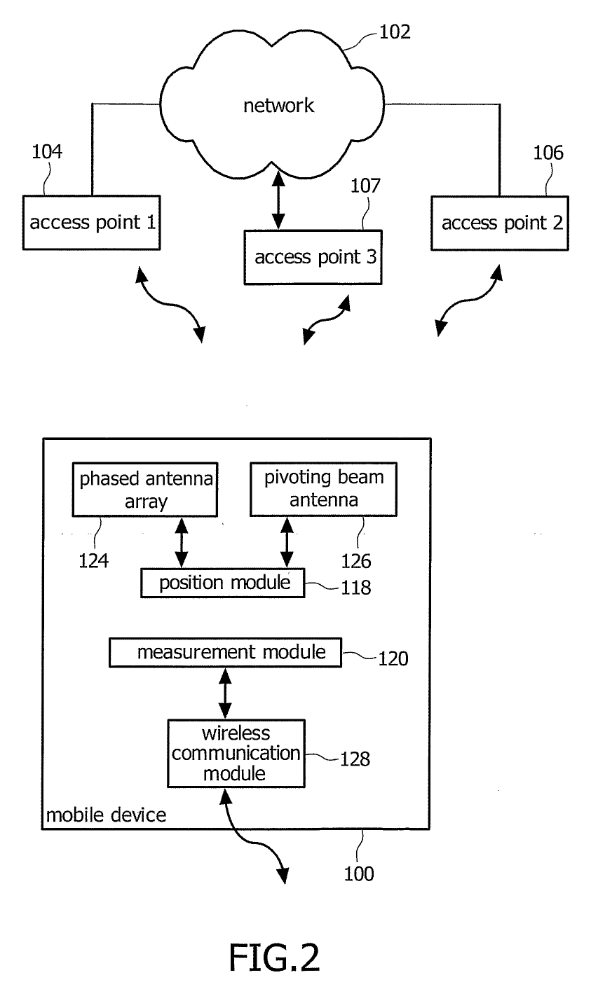

FIG. 2 illustrates a block diagram of a wireless data communication network and the mobile device,

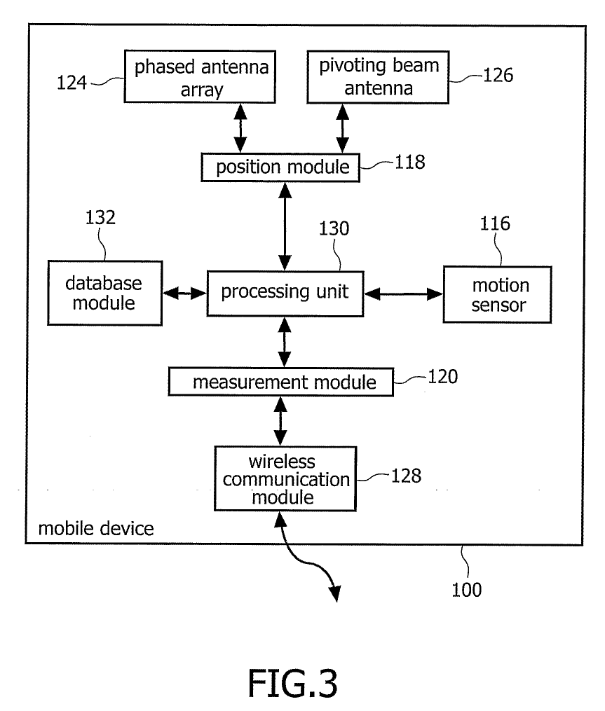

FIG. 3 illustrates a detailed block diagram of the mobile device,

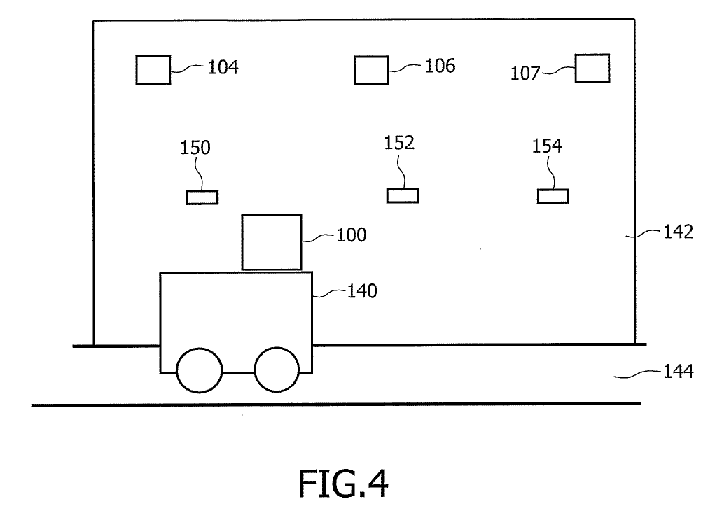

FIG. 4 schematically shows the mobile device attached to a trolley like device in a wireless data communication network environment,

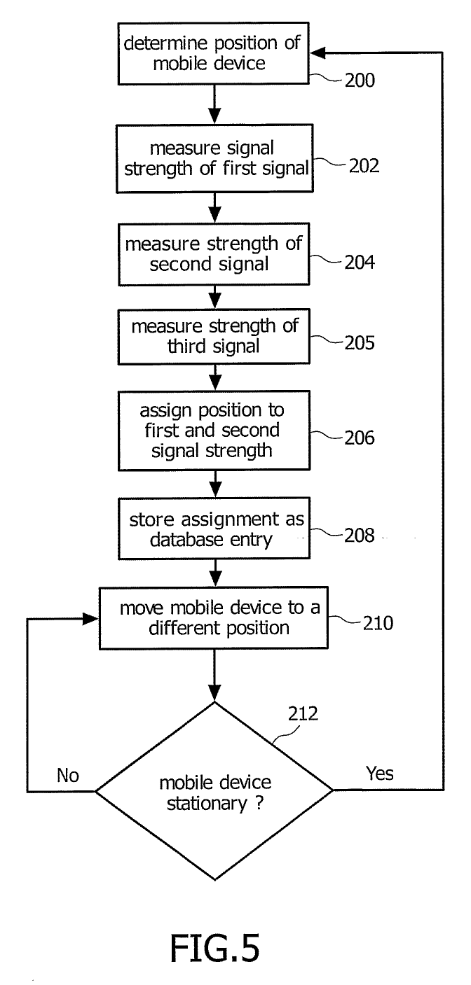

FIG. 5 depicts a flow chart of generating a database entry,

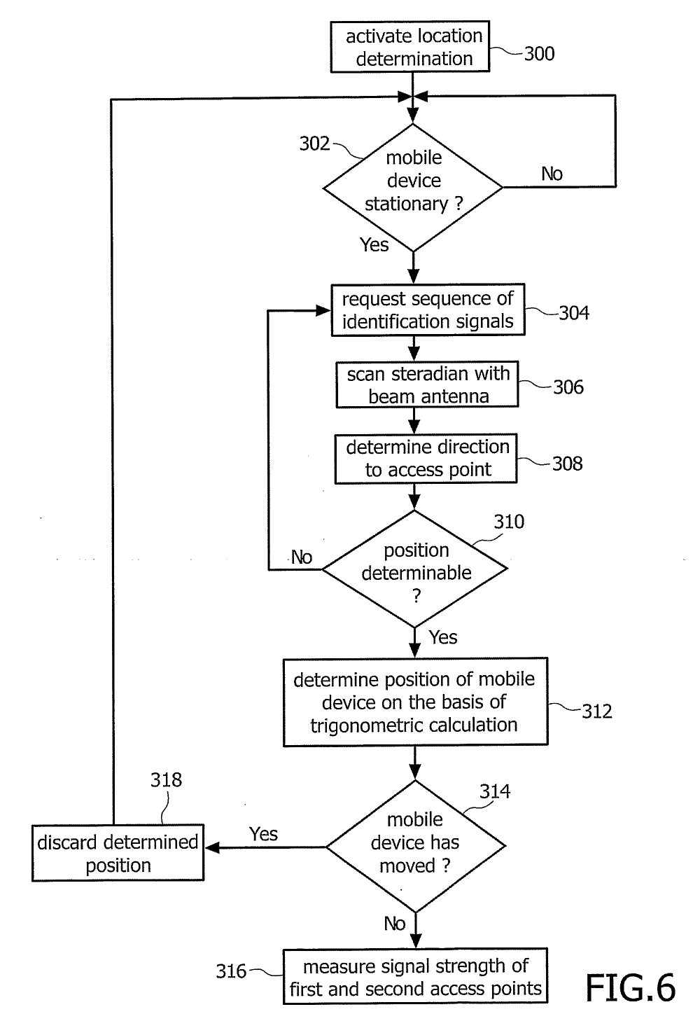

FIG. 6 is illustrative of a flow chart for determining the position of the mobile device by means of a trigonometric technique.

FIG. 1 shows a block diagram of a network system having a wireless data communication network 102, a mobile device 100 and a database 108. The wireless data communication network 102 has a first access point 104, a second access point 106 and a third access point 107. The wireless data communication network 102 may have further access points that are distributed over the area of coverage of the wireless data communication network 102.

The mobile device 100 has a motion sensor 116, a position module 118 and a measurement module 120. The motion sensor 116 is adapted to detect any motion of the mobile device 100 and the position module 118 is adapted to determine the position of the mobile device by making use of a trigonometric technique, such as triangulation or trilateration. The measurement module 120 of the mobile device 100 is adapted to measure the strength of signals that are wirelessly transmitted by the access point 104, access point 106 and access point 107. Since the signals that are emitted by access points 104, 106, 107 are transmitted in an undirected way, the signals are attenuated with increasing distance from the access points 104, 106, 107. Hence, the strength of the signals that are measured by the measurement module 120 strongly depends on the position of the mobile device with respect to the access points 104, 106, 107.

The position module 118 of the mobile device 100 is in turn adapted to determine the position of the mobile device 100. Determination of the position of the mobile device 100 is based on a trigonometric technique, such as e.g. trilateration or triangulation. In the illustrated embodiment position determination of the mobile device is based on a triangulation procedure by making use of a first, a second and a third reference point that in this case coincide with the access points 104, 106, 107. By determining a first angle or a steradian between the access point 104 and the mobile device 100, a second angle or steradian between access point 106 and mobile device 100 and a third steradion between access point 107 and the mobile device, the position of the mobile device 100 can be sufficiently determined provided that the mobile device 100 is only moveable within a two dimensional plane. Alternatively, the position determination can be expanded to a three dimensional position determination by making use of additional access points featuring three dimensional coordinates.

Determination of the position by means of the position module 118 and measuring of the strength of the first, the second and third signals that are transmitted by the access points 104, 106, 107 respectively can either be performed sequentially, simultaneously or within partially overlapping time intervals. Given that during a position measurement and a signal measurement the mobile device 100 remained stationary, the determined position is assigned to the measured first, second and third signals. This kind of assignment can be effectively realized by means of the database 108.

Therefore, the database 108 has at least three columns 110, 112, 114. For example, column 110 is adapted to store position data, column 112 is adapted to store signal strength information of access point 104 and column 114 is adapted to store signal strength information of access point 106. Typically the position data is granularized onto a grid of a defined grid size of e.g. 25 cm. This avoids over-accurate result storage and allows for repeated measurements in the same area to be recognized and averaged. In this way separately obtained position and signal strength information can be effectively mapped.

In the embodiment illustrated in FIG. 1 the database 108 is illustrated to be accessible by the mobile device 100 as well as by the wireless data communication network 102. Alternatively, the database 108 can be stored in the mobile device 100 or it can be stored by means of the network 102.

FIG. 2 illustrates a block diagram of the wireless data communication network 102 and the mobile device 100. Here, the wireless data communication network 102 also has access points 104, 106 and 107 and the mobile device 100 has a position module 118 as well as measurement module 120. Additionally and in contrast to FIG. 1, here, the mobile device 100 also has a wireless communication module 128, a phased antenna array 124 as well as a pivoting beam antenna 126. Hence, for determining the position of the mobile device, the position module 128 makes use of the phased antenna array 124 and/or of the pivoting beam antenna 126 that might be implemented as e.g. a parabolic antenna.

Both the phased antenna array 124 and the pivoting beam antenna 126 are adapted to receive identification signals that are wirelessly transmitted by the access points 104, 106, 107. The phased antenna array 124 is directly adapted to roughly determine the angle of incidence of the identification signals from access points 104, 106, 107 whereas the pivoting beam antenna 126 is adapted to scan a steradian in order to locate the location of access points 104, 106, 107. Preferably, the phased antenna array 124 provides a rough determination of the location of the two access points 104, 106, 107 and based on this rough estimation the pivoting beam antenna can be subsequently directed towards access point 104, thereafter to access point 106 and thereafter access point 107 to precisely determine the direction at which access points 104, 106, 107 can be located. The position module 118 controls the interplay between the phased antenna array 124 and the pivoting beam antenna 126.

Both antennas 124, 126 are adapted to determine an angle between the mobile device 100 and the two access points 104, 106, 107 respectively. By means of these at least two angles with respect to a known orientation of the mobile device, the position module 118 is adapted to calculate the position of the mobile device 100 because the position of the access points 104, 106, 107 is known to the mobile device 100 or at least to the network 102. In such cases, where the orientation of the mobile device is not accessible, at least three reference points are needed in order to sufficiently determine the mobile device's position.

Making use of position information of access points 104, 106, 107 in combination with the angles between the mobile device 100 and the access points 104, 106, 107 effectively allows to calculate the position of the mobile device 100. For three dimensional determination of the location of the mobile device 100, at least one additional access point is required.

Depending on the required resolution of the position determination it might already be sufficient to determine the position of the mobile device 100 only by means of the phased antenna array 124. In such cases where a precise position determination of the mobile device 100 is required, the position module 118 makes effective use of a combination of phased antenna array 124 and pivoting beam antenna 126. In particular by making use of a IEEE 802.11 wireless network environment, the phased antenna array 124 is preferably adapted to detect beacons that are regularly transmitted by the access points 104, 106, 107.

Since a sufficient angular scan to be performed by means of the pivoting beam antenna 126 requires a large amount of beacon messages, it is of advantage to request a sequence of identification signals from the access points 104, 106, 107. Such a request might be transmitted to the access points 104, 106, 107 by means of the wireless communication module 128 of the mobile device 100. The access points 104, 106, 107 will then transmit a sequence of identification signals featuring a substantially higher repetition rate than the beacons of the 802.11 standard. Therefore, by means of the wireless communication module 128, the mobile device 100 is also enabled to transmit signals to the wireless communication network 102 via the access points 104, 106, 107.

Preferably, the wireless communication module is implemented as a commercially available IEEE 802.11 wireless communication component. Moreover, by making use of the wireless communication module 128, the measurement module 120 is enabled to measure the signal strength of the signals that are transmitted from access points 104, 106, 107, respectively.

FIG. 3 is illustrative of a detailed block diagram of the mobile device 100. In addition to the illustration shown in FIG. 2 the mobile device 100 further has a processing unit 130, the motion sensor 116 and a database module 132. The position module 118 is adapted to determine the position of the mobile device 100 by making use of the phased antenna array 124 and the pivoting beam antenna 126. The measurement module 120 is adapted to measure the strength of signals that are transmitted by the access points 104, 106 by making use of the wireless communication module 128. The processing unit 130 controls the interplay between the database module 132, the position module 118, the motion sensor 116 and the measurement module 120. Hence, the processing unit 130 controls the overall functionality of the mobile device 100.

The database module 132 is adapted to store the database or at least parts of the database. The database that is stored in the database module 132 can be accessed by the processing unit 130 either for entering a new database entry, for updating a database entry, for deleting a database entry as well as for reading a database entry. The motion sensor 116 is adapted to detect whether the mobile device 100 is in a stationary position or subject to movement. If the motion sensor 116 indicates to the processing unit 130 that the mobile device is non stationary, either the measurement of signal strength or the determination of the position is aborted, deactivated, or the corresponding result will be discarded.

FIG. 4 schematically illustrates the mobile device 100 being attached to a trolley 140 that is adapted to be moved on a floor 144. The schematic illustration of FIG. 4 refers to a floor inside a building and an adjacent wall 142. The wall 142 has three spatially separated reference points 150, 152, 154 as well as access points 104, 106, 107 of the wireless data communication network. Here, the trolley 140 is shown in a rather abstract way. In general, it can be implemented as any kind of trolley like device that is frequently moved within the area of coverage of the wireless data communication network.

For example, the trolley can be implemented as a rack being used by cleaning personnel and that serves as a base frame for waste bin and/or buckets or that provides attachment means for brooms or similar cleaning appliances.

Preferably, the trolley 140 is moveable along the floor 144 and therefore the position of the mobile device 100 can only be changed with respect to two coordinates. In this implementation, the first and the second reference points 150, 152, 154 are sufficient for unequivocal determination of the position of the mobile device 100 by making use of a triangulation procedure. Here, the reference points 150, 152, 154 provide the functionality of transmitting beacons and/or identification signals that allow for position determination of the mobile device 100 on the basis of triangulation.

The position determination of the mobile device 100 by no means has to be restricted to an RF wireless transmission technique. Moreover, any kind of applicable triangulation procedure that may be based on even optical or infrared transmission means can be applied. Preferably, reference points 150, 152, 154 are located at the same height above the floor 144. The same applies to the access points 104, 106, 107. In this way errors referring to position determination and/or signal strength measurements can be reduced. Additionally, the system can also be implemented to access points and reference points that feature different heights above the floor 144.

FIG. 5 is illustrative of a flow chart for generating a database entry. In a first step 200 the mobile device determines its own position by making use of the trigonometric, preferably triangulation technique. Once the position of the mobile device has been precisely determined, in the following step 202 the first signal that is transmitted by the at least first access point of the wireless data communication network is measured. Measuring of this first signal refers to measuring the strength of the signal that serves as an indication of the distance between the mobile device and the at least first access point. Typically, the signals that are transmitted by the access points are transmitted as beacons that are specific for each of the at least first, second and third access points. Therefore, by receiving a transmitted signal, the mobile device is also enabled to assign the received signal to one of the at least first, second and third access points. In a successive step 204 the mobile device measures the strength of the second signal that is transmitted by the at least second access point of the wireless data communication network. Thereafter in step 205 the strength of the third signal being transmitted by the at least third access points is determined correspondingly.

In the depicted flow chart, steps 202, 204 and 205 are illustrated as sequential steps. However, measuring of the first, second and third signals can also be performed simultaneously. After the position of the mobile device has been determined in step 200 and the at least first, second and third signal strength of the first, second and third signals has been measured at the position of the mobile device in steps 202, 204, 205 in the following step 206 the determined position of the mobile device is assigned to the first, second and third signal strength. Thereafter in step 208 the assignment between position and first, second and third signal strengths is stored in the database as a database entry. Alternatively, step 206 may also be skipped since a separate storage of position and first, second and third signal strengths in the database inherently provides an assignment between position and corresponding signal strengths.

After the database entry has been stored in step 208 the mobile device can be moved to a different position in step 210. Moving of the mobile device is typically implemented as a by-product of a movement of another mobile device that may for example be used by cleaning personnel and that is subject to frequent moving within a building. After the mobile device has been moved to a different position in step 210, in the following step 212 it is checked whether the mobile device is in a stationary position. If in step 212 the mobile device is in a stationary position the method returns to step 200 and the entire procedure of determining the position of the mobile device measuring the signal strengths of the first and the second signal is repeatedly executed.

In such cases where in step 212 the mobile device is non stationary the method returns to step 210 where the mobile device is subject to a movement. Step 212 that provides checking of the stationary position of the mobile device is preferably implemented by making use of the motion sensor of the mobile device.

FIG. 6 is illustrative of a flow chart for determining the position of the mobile device by making use of a triangulation procedure. In a first step 300 the location determination procedure is activated. The location determination may be activated in response to the motion sensor indicating that the mobile device is in a stationary state. However, after activation of the location determination procedure in step 300 in the following step 302 it is checked whether the mobile device is in a stationary position. If in or after step 302 the mobile device is non stationary, the method returns to step 302 and repeatedly checks whether the mobile device is stationary. Only in case when the mobile device is stationary, the method continues with step 304 where the mobile device requests a sequence of identification signals from all or any one of the at least first, second and third reference or access points.

Hence, the mobile device makes use of its wireless communication module 128 in order to transmit a request to any of the reference or access points of the wireless network. Alternatively, in principle step 304 may be skipped when for example the wireless communication network is based on a IEEE 802.11 standard. In this case the access points of the network frequently emit beacon messages that in principle allow to determine a location of the mobile device relative to with respect to the location of the various access or reference points.

In step 306 the mobile device makes use of its beam antenna in order to scan a steradian for determining a relative angle at which a reference or access point of the network can be traced. Therefore, the beam antenna which is typically a parabolic antenna is scanned over a range of angles and for each angle a signal strength of the measured signal is monitored. It can be presumed that the maximum measured signal corresponds to the required angular information. Should there be several, clearly separated strength maxima of similar strength over the range of angles scanned, the corresponding measurement is ignored. In such a case it can be assumed that a direct direction to the reference point is obstructed and that only reflections are measured.

Consequently, in step 308 the scan performed in step 306 is processed in order to determine the direction to the first reference or access point. After this direction determination in the successive step 310, it is checked whether the collected direction information is sufficient in order to determine the position of the mobile device. When for example, steps 306 and 308 refer to the determination of an angle pointing to a first reference point only, additional angles pointing to the second and third access points have to be successively determined.

Step 310 therefore, checks if the position of the mobile device is already determinable. In case that directions to the first, second and third access points have been determined, the method continues with step 312, where the position of the mobile device is determined on the basis of a trigonometric calculation. Otherwise, when required direction information to second and third access points is still missing, the method returns to step 304, where the again a sequence of identification signals is requested from a second or third access point. The loop as described in steps 304 through 310 continues as long as sufficient direction data has been collected that allows for a precise determination of the mobile device.

After the directions to the first and the second access point have been determined, in step 312 the position of the mobile device is determined on the basis of a trigonometric calculation. Therefore, the mobile device also requires information of the position of the at least first, second and third reference or access points. Since the reference and access points are typically immobile as a part of the network infrastructure, their location can either be stored in the mobile device or can be transmitted via the wireless network to the mobile device.

Alternatively, the position determination of the mobile device can also be performed by means of a network component. In this case the mobile device has to transmit the measured direction to the first, second and third reference or access points to the wireless network by making use of the wireless communication module. Assuming that the mobile device is restricted to a two dimensional movement within a level of a building, unequivocal determination of the position of the mobile device at least requires measuring the direction to a first, second and third reference or access point.

In such cases where even additional reference or access points are available, the position determination of the mobile device may take into account these additional reference or access points. Then, a system of equations for determining the position of the mobile device might be over determined when any one of the directions to an access or reference point has been subject to a measurement error. Especially for such cases, the mobile device and its computer program product are accomplished with a weighting function that either allows to discard the measured values or to weight a determined position with neighboring positions.

After determination of the position of the mobile device in step 312 in the successive step 314 it is checked whether the mobile device has moved during position determination procedure. When in step 314 a movement has been detected, the method continues with step 318 in which the determined position is discarded. Hence in this case it can be assumed that the measured values are subject to a measurement error because of the movement of the mobile device. After step 318 the method returns to step 302 that describes a loop that is dedicated for checking whether the mobile device is stationary. In the opposite case when in step 314 no movement of the mobile device has been detected the method continues with step 316 where the signal strength of the signals that are transmitted by the first and the second access points is determined. Step 316 of FIG. 6 therefore corresponds to steps 202 and 204 of FIG. 5.

Preferably, any motion detection as described in step 314 is performed even more regularly, e.g. during the single steps for position determination. By frequently or almost constantly observing a movement of the mobile device, an ongoing position and/or signal strength measurement can be immediately discarded. As a consequence, another measurement may take place as soon as a another stationary position of the mobile device has been reached.

The present invention therefore provides a mobile device and a method for autonomously generating and updating a database that is indicative of location dependent signal characteristics of access points of a wireless communication network. Since the mobile device is preferably attached to a trolley like device that is subject to frequent movement through a building, a network administrator no longer has to measure the signal strengths at different locations manually.

### LIST OF REFERENCE NUMERALS

100 mobile device
102 network
104 access point
106 access point
107 access point
108 database
110 database column
112 database column
114 database column
116 motion sensor
118 position module
120 measurement module
124 phased antenna array
126 beam antenna
128 wireless communication module
130 processing unit
132 database module
140 trolley
142 wall
144 floor
150 reference point
152 reference point
154 reference point

1. A mobile device (100) for generating a database (108) for a wireless data communication network (102) having at least a first and a second access point (104, 106), the mobile device comprising:
means for determining a position (118) of the mobile device by means of at least a first, a second and a third reference point (150, 152, 154) on the basis of a trigonometric technique,
means for measuring at least a first signal being wirelessly transmitted by the at least first access point, for measuring at least a second signal being wirelessly transmitted by the at least second access point and measuring at least a third signal being wirelessly transmitted by the at least third access point.
means for storing the position, the at least first, second and third signal in the database.

2. The mobile device (100) according to claim 1, further comprising a motion detector (116) being adapted to determine if the mobile device is stationary.

3. The mobile device (100) according to claim 1, wherein the means for determining of the position (118) of the mobile device being adapted to make use of a tilting beam antenna (126) and/or a phased antenna array (124).

4. The mobile device (100) according to claim 1, further comprising a wireless communication module (128) for enabling wireless data transmission between any of the at least first, second and third access points (104, 106, 107) and the mobile device.

5. The mobile device (100) according to claim 1, further comprising means for requesting identification signals to be wirelessly transmitted by the at least first, second and third reference points (150, 152, 154).

6. The mobile device (100) according to claim 1, further comprising fixing means being adapted to attach the mobile device to a trolley-like device (140) being movable within the area of coverage of the wireless data communication network (102).

7. A network system comprising:
a wireless data communication network (102) having at least a first, a second and a third access point (104, 106, 107),
a mobile device (100) being adapted to determine its position by means of at least a first, a second and a third reference point (150, 152, 154) on the basis of a trigonometric technique and being further adapted to measure at least a first, a second and a third signal being wirelessly transmitted by the at least first, second and third access points,
a database (108) being adapted to store the location of the mobile device with the strength of the at least first, second and third signals.

8. The network system according to claim 7, wherein the at least first, second and third access points (104, 106, 107) serve as the at least first, second and third reference points (150, 152, 154).

9. A method of generating a database (108) for a wireless data communication network (102) having at least a first, a second and a third access point (104, 106, 107), the method making use of a mobile device (100) and comprising the steps of:
determining a position of the mobile device by means of at least a first, second and third reference point (150, 152, 154) on the basis of a trigonometric technique,
measuring at least a first, a second and a third signal being wirelessly transmitted by the at least first, second and third access points, the at least first, second and third signals being measured by the mobile device,
assigning the at least first, second and third signals to the position of the mobile device,
storing of the assignment between the at least first, second and third signals and the position of the mobile device as an entry of the database.

10. A computer program product for generating a database (108) for a wireless data communication network (102) having at least a first, a second and a third access point (104, 106, 107), the computer program product comprising:
program means for performing a trigonometric calculation procedure for determining a position of a mobile device by means of at least a first, a second and a third reference point (150, 152, 154),
program means for assigning the position of the mobile device with at least a first, a second and a third signal being transmitted by the at least first, second and third access points (104, 106, 107) and being measured by the mobile device,
program means for storing of the assignment between the at least first, second and third signals and the position of the mobile device as an entry of the database.

11. The computer program product according to claim 10, further comprising computer program means being adapted to perform a weighting procedure between at least a first and a second database entry if the distance between the position of the first database entry and the second database entry is below a predefined threshold.

12. The computer program product according to claim 10, further comprising computer program means being adapted to discard a trigonometric calculation if during determination of the position a motion of the mobile (100) device being detected by means of a motion sensor (116).
